(19) United States
(12) Patent Application Publication
(10) Pub. No.: US 2008/0164117 A1
(43) Pub. Date: Jul. 10, 2008

(54) Conveyor device comprising a barrier and method for modernizing a conveyor device

(76) Inventors: Andreas Drahohs, Vienna (AT); Gerhard Kleewein, Pressbaum (AT); Gerhard Bock, Heiligeneich (AT)

Correspondence Address: SCHWEITZER CORNMAN GROSS & BONDELL LLP, 292 MADISON AVENUE - 19th FLOOR, NEW YORK, NY, 10017, US

(21) Appl. No.: 11/811,779

(22) Filed: Jun. 12, 2007

Related U.S. Application Data
(63) Continuation of application No. PCT/CH05/00605, filed on Oct. 18, 2005.

(30) Foreign Application Priority Data
Oct. 22, 2004 (EP) EP 04105249.9

(51) Int. Cl. B66B 21/00

(52) U.S. Cl. 198/321

(57) ABSTRACT

A conveyor device includes a balustrade supporting a handrail and a transport surface for conveying passengers. A barrier is located at the balustrade and extends upwardly beyond the balustrade and handrail to protect passengers from falling from the conveyor device.

The present application is a continuation of PCT/CH2005/000605, filed Oct. 18, 2005, the contents of which are incorporated by reference herein.

### BACKGROUND OF THE INVENTION

The invention relates to a conveyor device and to a method of modernizing a conveyor device.

Conveyor devices in the sense of the invention are escalators and moving walkways with a plurality of steps or plates, which are connected to form an endless conveyor for conveying users and/or other loads, such as luggage or shopping trolleys. The steps or plates form a conveying surface.

Balustrades are usually arranged laterally of the steps or plates of the conveyor device. A support system, to which the balustrade is fastened, is disposed in the region of each balustrade. The support system is covered from above by a cover arrangement and laterally by a side cladding. The cover arrangement and the side cladding are usually fastened with the help of fastening means to the support system, which is also constructed to accommodate the fastening means.

Conventional conveyor devices are matched with respect to the balustrade height and the height of the handrail, and for this purpose exclusively for safe use of the escalator or moving walkway, which is also desired in corresponding building regulations. These building regulations have to be adhered to unconditionally by the operators or the clients of builders.

Since the balustrades of conventional conveyor devices only reach up to the height of the handrail, these conveyor devices may be risky for very large passengers, insofar as the centers of gravity thereof lie above the balustrade or the handrail. Such passengers could, in certain circumstances, fall over the balustrade.

Moreover, it happens nowadays that passengers deliberately jump over the balustrade, or that passengers are involuntarily thrown over the balustrade. This may happen, for example, in a football stadium when hooligans fall down from a conveyor device or throw other passengers down from the conveyor device.

Such situations are risky for passengers of the conveyor devices and also for persons located below the conveyor device and therefore are to be eliminated or absolutely avoided.

Patent Specifications EP 1142821 and JP 08002866 disclose a barrier, arranged at the balustrade for safeguarding passengers of the conveyor device against falling off, which barrier extends above the height of the balustrade or the handrail. The barrier is of very solid construction, heavy, and has a number of mechanically complex components. Such a barrier is therefore expensive and installation thereof is time-consuming.

Clips in the form of conventional metal brackets or bracket profile members are used for mounting the barrier according to EP 1142821. These clips hold a shaped or profiled tube, whereby a base frame (supporting framework or supporting skeleton) of the protective wall is formed. Beyond this, at the lower end of each shaped tube or profiled tube U-shaped profile members (approximately 25 to 30 pieces per escalator side) are welded to the framework as an additional end fastening or end mounting. The connecting of these U-shaped profile members requires extra welding work as well as additional material outlay inclusive of the welding electrodes and additional work for cutting to length and for calibrating. Two partition walls are then mounted on the formed base frame by a plurality of suitable fastening elements. The partition walls usually consist of chipboard or plasterboard sheets in order to provide a light-weight construction. Such partition walls are sensitive to concentrated loads and can be effortlessly pressed in locally. Finally, a cover profile member or a cover plate is placed over the entire length of the partition walls. The fastening of the cover profile member is carried out by way of a number of clip springs (approximately 40 to 50 per escalator side).

It is therefore the object of the invention to provide an improved conveyor device with an arranged barrier for protection of passengers of the conveyor device of the kind stated in the introduction, from falling off, which does not have the above-mentioned disadvantages and which is economical, practical, light, simple and quick in mounting and positioning.

### BRIEF DESCRIPTION OF THE INVENTION

In accordance with the foregoing and other objects, a conveyor device with a balustrade for supporting a handrail and with a conveying surface for conveying passengers of the present invention is characterized in that a barrier for safeguarding the passengers of the conveyor device against falling off is arranged at the balustrade. The barrier rises above the height of the balustrade of the handrail and is fastened near the handrail, i.e. laterally at the balustrade approximately at the same height at which the hands of passengers hold the handrail. The barrier is thus advantageously mounted in an upper region of the balustrade to be readily accessible. It consists of a small number of components and can be mounted quickly and simply. For example, the barrier can be mounted by an engineer standing on the conveying surface of the escalator.

The conveyor device offers the advantage that the barrier is higher than the balustrade or the inner cladding and thus, as a barrier, prevents falling of passengers from the conveyor device. Advantageously the barrier reaches to shoulder height of a conveyed passenger standing upright on the conveying surface. The shoulder height in Europe is approximately 150 cm.

Such a conveyor device offers the advantage that the barrier is constructed to be of such a height that deliberate falling down or falling off of passengers from the conveyor device is virtually impossible. Advantageously the barrier reaches to head height of the conveyed passengers standing upright on the conveying surface. The head height in Europe is approximately 170 cm. The conveyor device thus offers the advantage of an even higher safeguarding of the passengers against falling off, whereby a deliberate or voluntary jumping of a passenger down off the conveyor device is made virtually impossible, and in addition climbing over the same is very difficult.

Advantageously, balustrade clips are arranged and fastened as accurately as possible and precisely on a balustrade upright by means of a device. Re-adjustment of the clips, preferably diecast aluminium clips, is thereby no longer needed, since their height and their horizontal position or lateral arrangement exactly correspond with the construction.

In a preferred form of embodiment of the invention the barrier may consist of toughened glass or of laminated safety glass, preferably of 10 mm thickness.

The barrier is advantageously of transparent construction and enables natural lighting of the conveyor device by solar radiation. The passengers thus have the possibility of looking at the surroundings. In addition, the aesthetic impression of the conveyor device is improved. By contrast thereto, conventional, non-transparent partition walls form a screen or tunnel. Such a tunnel has an effect on the passengers which is perceived as unpleasant, this effect also being described in relevant technical literature as tunnel syndrome.

In further preferred forms of embodiment the barrier consists of ‘Plexiglas’ brand or acrylic glass, stainless steel, steel plate, aluminium plate, granite or marble. In addition, diverse modes of sandwich construction of different materials are possible for construction of the barrier. Thus, the barrier may consist of glass or toughened glass backed by perforated plate or corrugated-perforated plate. In that case a perforated or corrugated-perforated sheet metal plate is positioned behind the glass, whereby a form of fence effect or barrier effect arises. The different materials can be connected or glued to form a sandwich component.

The barrier can thus be realized through conventional, economic constructional materials. It can be of very robust construction in order to withstand forcible attacks exerted by vandals or hooligans. Here, too, the aesthetic impression of the conveyor device has an agreeable effect.

Advantageously, the balustrade includes balustrade clips which hold the barrier for safeguarding against falling off and which are mounted on the balustrade or on the inner or outer cladding. Mounting of the barrier in the balustrade can thereby be carried out quickly, economically and simply. The barrier can, without problems, be detached, demounted, exchanged and, in certain circumstances, reused. The balustrade clip is preferably a diecast aluminium clip which, by means of a wedge system, enables whole-area pressing over one or two surfaces on the safety glass. In addition, the diecast aluminium clip is a precision part and enables more accurate positioning of the barrier than hitherto possible.

It is particularly advantageous if the balustrade clips are fastened to a balustrade upright by means of balustrade clip screws and balustrade clip nuts. The balustrade clips are thus firmly connected with the balustrade. The fastening is of very robust construction. Correspondingly, the fastening of the barrier is also very robust and solid.

A barrier with a barrier fastening mount which holds the barrier and serves for mounting on the balustrade has proved particularly advantageous.

The position of the barrier relative to the balustrade clips can be set in a defined manner very precisely in that relative movements between the barrier and the barrier fastening mount holding the barrier are corrected. Correspondingly, the fastening of the barrier relative to the balustrade can also be adjusted in a simple manner. The barrier fastening mount is preferably a continuous cold-formed profile member, which is processed extremely precisely and thereby forms a support body, which is accurate to size, for the barrier. Moreover, the barrier fastening mount is the lower end abutment or the lower end termination for the glass barrier. The height and lateral arrangement of the glass barrier can thereby be maintained exactly and precisely. In addition, the mechanical strength of the glass barrier is substantially increased by the barrier fastening mount. Beyond that, the barrier fastening mount forms a self-supporting supportive unit which positions the safety glass in height over the entire length of the escalator. In addition, the barrier fastening mount transmits the clamping action to the safety glass over the whole area. An improved fastening or mounting is thereby provided and the risk of glass breakage reduced to a minimum.

The recited object is additionally fulfilled through a modernization of a conveyor device with a balustrade for supporting a handrail and with a conveying surface for conveying passengers by the provision of the inventive barrier for safeguarding passengers of the conveyor device against falling off which is arranged at the balustrade, which barrier rises above the height of the balustrade or handrail and is fastened near the handrail.

The modernization method according to the invention offers the advantage that an existing conveyor device can be made significantly safer in a simple, rapid and cost-saving manner. The barrier forms a higher barrier for protection of the passengers from falling off than the balustrade itself. Falling-off of passengers down from the conveyor device is thereby prevented.

### BRIEF DESCRIPTION OF THE DRAWINGS

Further details and advantages of the invention are described in the following detailed description setting forth an exemplary embodiment with reference to the figures, in which:

FIG. 1 shows a conveyor device according to the invention in the form of an escalator, in simplified illustration, from the side;

FIG. 2 shows a partial cross-section of the conveyor device taken along line 2-2 in FIG. 1;

FIG. 3 shows an enlarged view of the fastening of the barrier to the balustrade; and

FIG. 4 shows a side view of the fastening of the barrier to the balustrade.

### DETAILED DESCRIPTION OF THE INVENTION

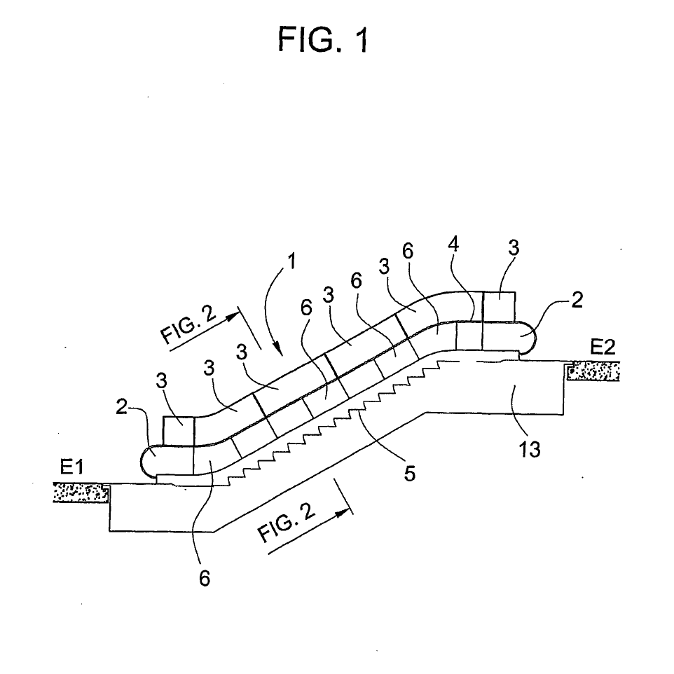

FIG. 1 shows a conveyor device 1 in the form of an escalator which extends between a lower story E1 and an upper story E2. The conveyor device has stationary balustrades 2 at both sides of the movable conveying surface 5 in the form of a step belt. An inner cladding 6 is fastened to a framework 13 or support system. A handrail 4 runs along the upper edge of each stationary balustrade 2 substantially synchronously with or slightly leading the steps (105 to 110% of the step speed).

A barrier 3 for safeguarding the passengers of the conveyor device 1 against falling off is arranged near the handrail 4, which barrier 3 exceeds the height of the balustrade 2 or the handrail 4. The invention represents an efficient safeguarding, above the inner cladding 6, against falling off. Possible falling-off of passengers over the balustrade 2 is thereby prevented.

The surface of the barrier 3 can be closed and the barrier 3 thus forms a whole-area protection against falling off. However, the surface of the barrier 3 can also be partly open and the barrier 3 thus forms, for example, a grid-shaped, column-shaped or row-shaped protection against falling off.

With knowledge of the present invention the expert can also equip a moving walkway with such a barrier.

The height of the barrier 3 is freely selectable in dependence on the requirements of use. By way of example, the barrier 3 reaches to shoulder height or head height of a conveyed passenger standing upright on the conveying surface. The shoulder height in Europe amounts to approximately between 100 and 170 cm. The head height in Europe is approximately between 150 and 210 cm. Obviously the expert can, with knowledge of the invention, also realize even smaller or larger barriers 3. In a preferred form of embodiment of the invention the barrier 3 reaches to 1 to 2 meters above the handrail (up to twice shoulder height). Such an embodiment offers the advantage that the passengers cannot grip the upper edge of the barrier 3 with their hands.

In a preferred form of embodiment of the invention the barrier 3 consists of toughened glass, also called TG. The thickness is between 5 and 20 mm. Moreover, the barrier or falling-off protection 3 for the escalator or the moving walkway 1 can also consist of laminated glass 3.1, also termed LG. The laminated glass 3.1 in turn again consists of two layers of toughened glass (TG), and disposed between the glass panes is a double-sided adhesive film or an adhesive layer of single-component or multi-component adhesive.

The use of toughened glass or laminated glass 3.1 guarantees sufficient stability and security of the barrier 3 against breakage, vandalism and inappropriate handling, as well as against damage in transport. Falling-off of a passenger over the balustrade 2 is thereby made almost impossible.

The barrier 3 for safeguarding against falling off is, in this embodiment of the invention, transparent and clear and enables natural lighting of the conveyor device 1 by solar radiation. Moreover, the passengers have the possibility of viewing the surroundings. The aesthetic impression of the conveyor device 1 is not impaired by the transparent barrier 3.

In further forms of embodiment the barrier 3 may consist of ‘Plexiglas’ brand acrylic sheet, acrylic glass, stainless steel, steel plate, aluminium plate, granite or marble. Such materials are conventional in the construction industry, are economical and offer good mechanical properties. Moreover, all forms of sandwich materials, thus different materials joined together or glued, are possible.

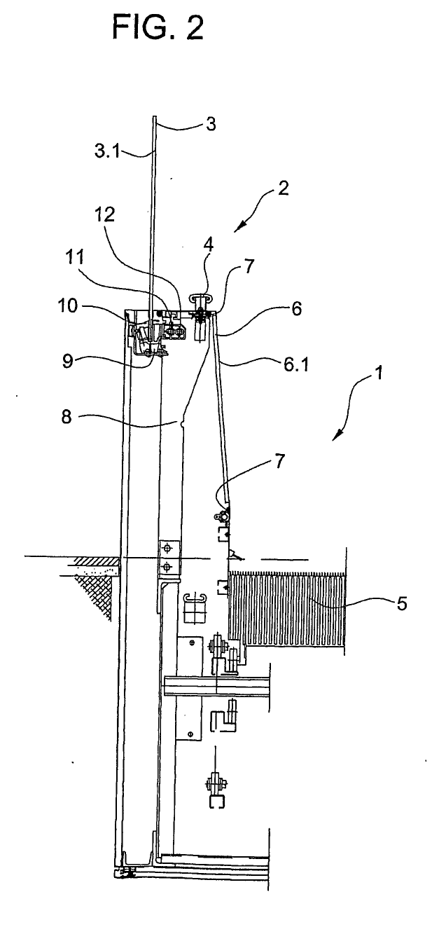

FIG. 2 shows a partial cross-section of the conveyor device 1 illustrated in FIG. 1. The inner cladding 6 is exchangeably fastened at the top and bottom between the balustrades 2 and the step belt 4 at an inclination by means of inner cladding springs 7.

In the case of the illustrated balustrade type, which is also known as an inclined balustrade, the balustrade 2 supports the handrail 4 and fixes the plate of the inner cladding 6 by the inner cladding springs 7. The plate of the inner cladding 6 consists of steel plate cartridges provided with a plate filling 6.1.

The barrier 3 is equipped with a barrier fastening mount 10 which holds the safety pane 3.1 in its position and allocates thereto the correct height. Such a barrier fastening mount 10 is particularly helpful in mounting when the height of the barrier 3 has to be precisely adjusted. The height of the barrier fastening mount lies between 20 and 100 mm.

The barrier or falling-off protection 3 is clipped or mounted from below by a few balustrade clips 9. These are in turn fastened appropriately at the balustrade upright 8 in order to obtain a highest possible barrier 3. The balustrade clips 9 are screw-connected together with or fastened to the balustrade uprights 8, which are made of steel plate, by balustrade clip screws 11 and balustrade clip nuts 12.

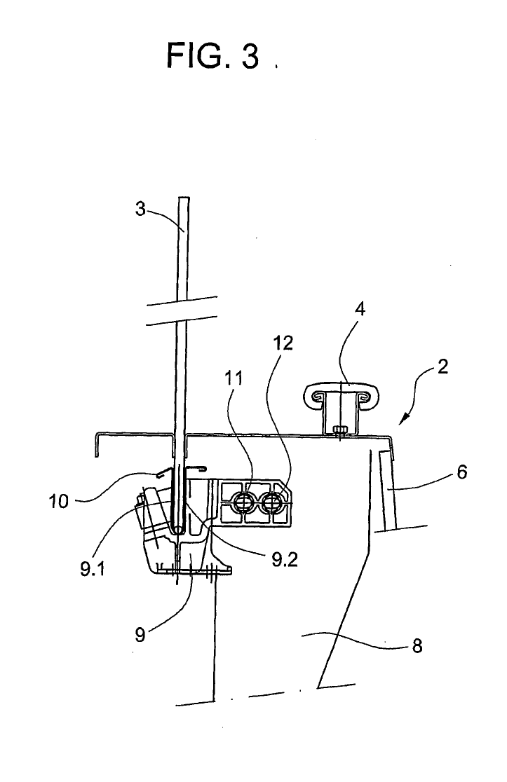

FIG. 3 is a view, to enlarged scale, of the fastening of the barrier 3 to the balustrade 2 of FIG. 2. FIG. 3 shows in detail that the barrier 3, which consists of toughened glass or laminated glass 3.1, is guided and fixed in the correct position in the balustrade clip 9 by means of a mounting profile member, i.e. the barrier fastening mount 10. The balustrade clip 9 engages around the barrier 3 over the whole area over two surfaces 9.1. and 9.2, and is provided in the lower region of the barrier 3. The two surfaces 9.1 and 9.2 lie on two opposite sides of the barrier. Over the whole area means that the pressure is not punctiform and not lineal, but is areal.

The barrier 3 can, through release of the balustrade clip 9, be detached, demounted, exchanged and reused in a problem-free manner.

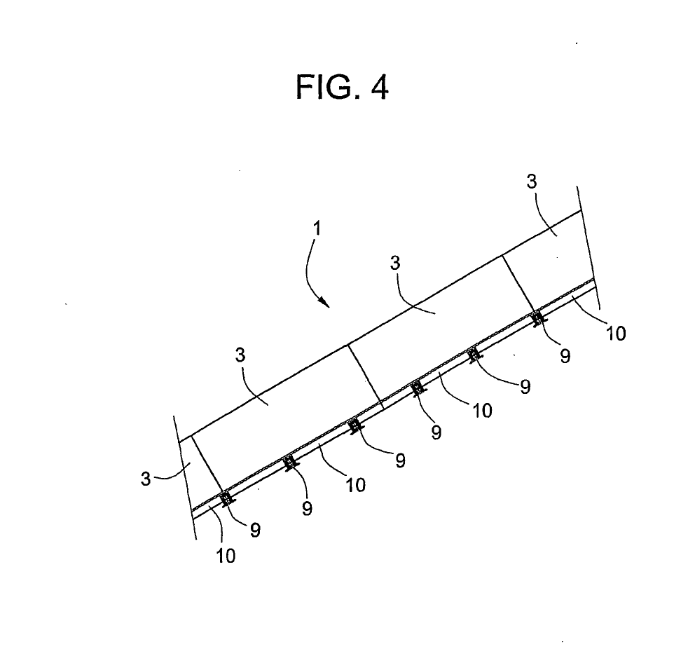

FIG. 4 is a side view of the fastening of the barrier 3 to the balustrade 2 of FIG. 3 and FIG. 2. The barrier fastening mount 10 is constructed as a continuous, long and slender profile member, but can also be present only in partial or discontinuous form, merely at the balustrade clips 9. The length used for the barrier fastening mount 10 is then usually approximately 300 mm to 500 mm. Beyond that the barrier 3 is fastened to the balustrade upright 8 by several balustrade clips 9. The balustrade uprights 8 are in turn fastened or welded to the supporting frame 1 every 400 mm to 1600 mm.

The described mechanical components of the conveyor device 1 according to the invention help with the modernization of an existing conveyor device 1 when the conveyor device is provided with a balustrade 2 for supporting a handrail 4 and with a conveying surface for conveying passengers and a simple, quick and economic method is sought in order to make the conveyor device 1 safer or more secure against falling off. Accordingly, a barrier 3 is preferably mounted at the balustrade 2, near the handrail, for safeguarding passengers of the conveyor device 1 against falling off, which barrier 3 extends above the height of the balustrade 2 or the handrail 4. The barrier 3 can be mounted at the outer side on the balustrade 2 or plugged onto or at or welded to the balustrade 2.

The barrier 3 can be precisely positioned and adjusted by the balustrade clips 9 and by the barrier fastening mount 10 in that small relative movements between barrier 3 and balustrade clips 9 can be made. The position of the barrier fastening mount 10 can also be adjusted. In addition, the barrier 3 can be adjusted in a simple manner and exchanged or replaced. For example, a new safety glass 3.1 with a different height, size, thickness and colour can be inserted in problem-free manner by detaching the balustrade clips 9.

We claim:

1. A conveyor device with a balustrade for supporting a handrail and a conveying surface for conveying passengers, and a barrier for safeguarding the passengers of the conveyor device against falling off arranged at the balustrade, the barrier rising above a height of at least one of the balustrade or handrail, the barrier being is fastened to the balustrade near the handrail.

2. The conveyor device according to claim 1, wherein the balustrade comprises at least one balustrade upright, the barrier being fastened to a balustrade upright near the handrail by balustrade clips.

3. The conveyor device according to claim 1 or 2, characterised in that the barrier projects above the conveyor surface by more than 1.5 meters.

4. The conveyor device according to claim 1 or 2, wherein the barrier comprises toughened glass or laminated safety glass.

5. The conveyor device according to claim 1 or 2, wherein the barrier comprises at least one of acrylic sheet, acrylic glass, stainless steel, steel plate, aluminium plate, granite or marble.

6. The conveyor device according to claim 2, wherein the balustrade clips holding the barrier exert a pressure on the barrier over a whole contact face of the clips.

7. The conveyor device according to claim 6, wherein the balustrade comprises at least one balustrade upright, the balustrade clips being fastened to a balustrade upright by means of balustrade clip screws and balustrade clip nuts.

8. The conveyor device according to claim 1 or 2, wherein the barrier has a U-shaped barrier fastening mount for at least one of mounting, adjustment of, and positioning the barrier with respect to the balustrade.

9. A method for modernizing a conveyor device having a balustrade for supporting a handrail and a conveying surface for conveying passengers, comprising the affixation of a barrier for safeguarding the passengers of the conveyor device against falling off to the balustrade in a manner in which barrier rises above a height of the balustrade or the handrail, the barrier being fastened to the balustrade near the handrail.
